(19) United States
(12) Patent Application Publication
(10) Pub. No.: US 2012/0010813 A1
(43) Pub. Date: Jan. 12, 2012

(54) Device for Backing Up Calibration Information and Aircraft Instrument Panel Including the Device

(75) Inventors: Florent COLLIAU, Chambon sur Cisse (FR); Frédéric GARDERE, Vendome (FR); Yves JAULAIN, Scorbe Clairvaux (FR)

(73) Assignee: THALES, Neuilly-sur-Seine (FR)

(21) Appl. No.: 12/978,232

(22) Filed: Dec. 23, 2010

(30) Foreign Application Priority Data
Dec. 30, 2009 (FR) 09 06404

(51) Int. Cl. G01C 23/00; G01C 21/00

(52) U.S. Cl. 701/525; 701/540; 701/408

(57) ABSTRACT

A device is provided for backing up calibration information for an air navigation instrument intended to be installed in an aircraft, the air navigation instrument comprising a first connector intended to be connected to a second connector belonging to the aircraft. The invention also relates to an aircraft instrument panel including the device. According to the invention, the backup device is connected between the first and the second connectors. The device comprises a third connector similar to the first connector and connected to the second connector and a fourth connector similar to the second connector and connected to the first connector. All the links from the second connector pass through the device to the fourth connector with no electrical interaction with the device. The device comprises backup means, connected only to the air navigation instrument, by means of the first and fourth connectors.

### CROSS-REFERENCE TO RELATED APPLICATION

This application claims priority to foreign French patent application No. FR 0906404, filed on Dec. 30, 2009, the disclosure of which is incorporated by reference in its entirety.

### FIELD OF THE INVENTION

The invention relates to a device for backing up calibration information and an aircraft instrument panel including the device.

### BACKGROUND

The instrument panel of an aircraft comprises numerous navigation instruments which have to be removable for maintenance operations. More specifically, on board aircraft, periodic checks on the correct operation of the navigation instruments are regularly scheduled. In particular, regulatory checks take place before each aircraft take-off. In the event of a failure of an instrument, the regulatory procedure may demand the replacement of the defective instrument before take-off. It is therefore necessary for the removal of the navigation instrument and the re-installation of a new replacement instrument to be able to be done in the shortest possible time.

Some navigation instruments are coupled to sensors or include sensors that require complex calibration. For example, an instrument comprising a magnetometer used to give the heading of the aircraft must be calibrated in its operational environment. In practice, the magnetometer is intended to measure the earth's magnetic field. The other instruments of the aircraft disturb the magnetometer measurement. These disturbances may lead to heading errors of several tens of degrees. All these errors together are often known as magnetic deviation. It is, however, possible to correct this deviation. A conventional calibration procedure provides for the aircraft to be oriented on the ground according to known directions and, for each direction, for the difference between the heading measurement made by means of the magnetometer and the real heading of the aircraft to be noted. From these differences, and by using compensation algorithms, it is possible to correct the measurement error and thus deliver reliable information to the pilot of the aircraft.

This type of calibration may take several hours and, for commercial aeroplanes, it is difficult to envisage carrying it out before a take-off, particularly when the passengers are already present onboard. Another procedure can be used to perform the calibration in flight. This procedure is also difficult to implement.

It has been found that the various calibration parameters, such as the magnetic deviation, are essentially dependent on the aircraft and can be reused if the navigation instrument is replaced. It is possible to remove the damaged instrument, recover its calibration parameters so they can be re-entered into the new instrument when it is installed. This procedure makes it possible to avoid complete calibration of the new instrument but requires a specific maintenance rig for the calibration information to be exported from the damaged instrument to the replacement instrument.

### SUMMARY OF THE INVENTION

One object of the invention is to enable an instrument that requires calibration to be replaced without any specific maintenance rig.

Another object of the invention is a device firmly attached to the aircraft that makes it possible to recover the calibration parameters from an instrument that is being replaced.

In a preferred embodiment, it is an object of the present invention, to provide a device for backing up calibration information for an air navigation instrument intended to be installed in an aircraft, the air navigation instrument comprising a first connector intended to be connected to a second connector belonging to the aircraft, wherein the device is designed to be connected between the first and the second connectors, wherein the device comprises a third connector similar to the first connector and designed to be connected to the second connector and a fourth connector similar to the second connector and designed to be connected to the first connector, wherein all the links from the second connector pass through the device to the fourth connector with no electrical interaction with the device, and wherein the device comprises backup means connected only to the air navigation instrument by means of the first and fourth connectors.

Yet another object of the invention is to provide an aircraft instrument panel comprising a backup device according to the invention and an air navigation instrument.

The invention makes it possible to employ a backup device without modifying the wiring already present in the aircraft.

### BRIEF DESCRIPTION OF THE DRAWINGS

The invention will be better understood and other advantages will emerge from reading the detailed description of an embodiment given as an example, the description being illustrated by the appended drawing in which:

FIG. 1 is a perspective view of a standby instrument;

FIG. 2 represents the instrument of FIG. 1 mounted in an instrument panel of an aircraft;

FIG. 3 represents, inside the instrument panel, a backup device associated with the standby instrument;

FIG. 4 represents the interior of the backup device.

In the interests of clarity, the same elements are given the same identifiers in the various figures.

### DETAILED DESCRIPTION

The invention is described in relation to a standby instrument fitted in the instrument panel of an aircraft. It is obviously possible to implement the invention for other navigation instruments such as, for example, primary instruments.

A standby instrument is used to determine and display, independently, an altitude, a speed, an attitude and a heading of the aircraft from sensors belonging to the instrument. In the event of a fault in the primary instruments or display faults on the primary display screens, the screen of the standby instrument is used by the pilots of the aircraft. In the flight phase, even if the primary instruments are operational, the pilots still observe the screen of the standby instrument and note any deviations with respect to the information delivered by the primary instruments.

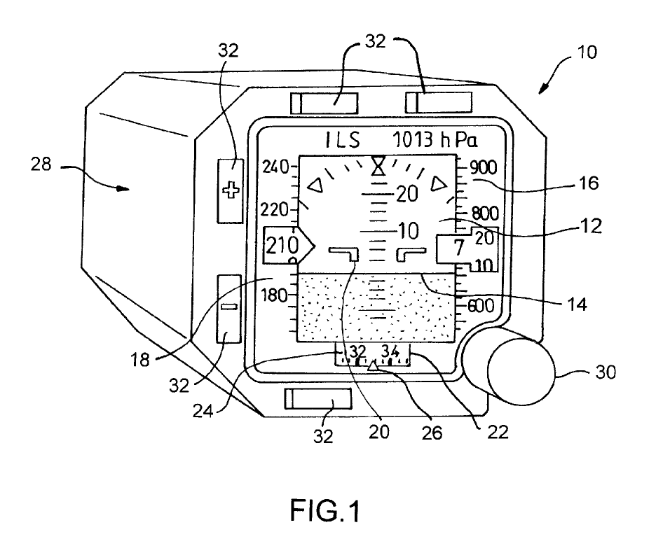

FIG. 1 represents a combined standby instrument 10 with which the instrument panel of an aircraft is equipped. The standby instrument 10 includes a colour screen 12 for displaying a horizon 14 (earth in brown below, sky in blue above) and standby data required for the piloting, namely mainly altitude in the form of a scrolling graduated scale 16 on the right, speed in the form of another scrolling graduated scale 18 on the left, and an aircraft attitude symbol 20. An area 22 is reserved for the heading information, also presented in the form of a scrolling graduated scale 24 in front of a fixed cursor 26.

The display of the horizon and of the numerical speed, altitude and heading data is determined by a computer 28 situated in the body of the standby instrument 10 based on signals originating from sensors, some of which are external to the instrument 10 and of which others may be inside or outside the instrument 10. The sensors are generally pressure sensors (for speed and for altitude), an inertial measuring unit for the attitude and one or more magnetic field sensors, commonly called magnetometers, for the heading. Advantageously, the pressure sensors, the inertial measuring unit and the magnetometer are situated inside the standby instrument 10. The pressure sensors are linked to pressure points situated on the skin of the aircraft and are used to measure the static pressure and the overall pressure of the air surrounding the aircraft.

The standby instrument 10 generally comprises an adjustment knob 30 for realigning the atmospheric pressure according to data communicated locally (for example, supplied by the weather services in the vicinity of an aircraft). It includes other control knobs 32 for various uses (horizon realignment, placement on the screen of authorized speed or altitude range marks, etc.).

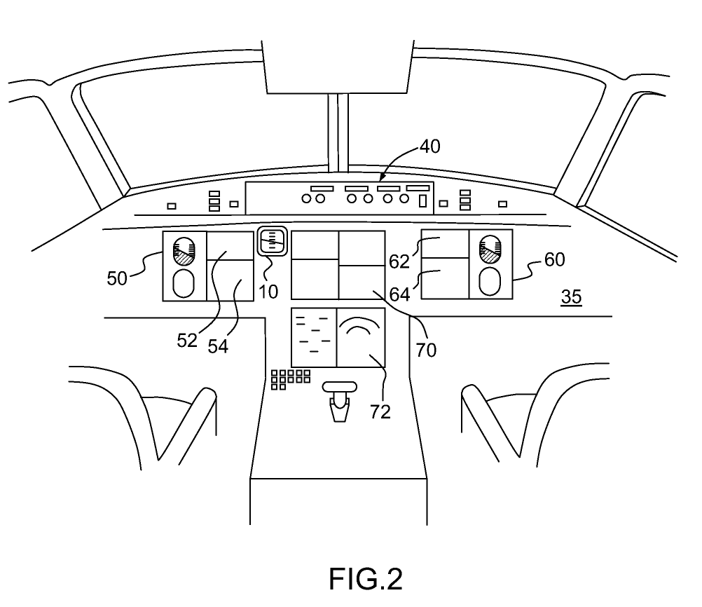

FIG. 2 represents a passenger transport aeroplane instrument panel 35, with pilot station and co-pilot station. The main display system comprises a number of piloting and navigation screens. For piloting, the horizon and the piloting data are displayed on a screen 50 for the pilot and a screen 60 for the copilot. Other screens 52, 54, for the pilot, 62, 64 for the copilot, and 70, 72 common to pilot and copilot provide other indications that are useful to the piloting or navigation. The standby instrument 10 is placed on the pilot's side. A sole automatic piloting control panel 40 is placed above all the piloting and navigation display systems. Some large carrier aeroplanes have two standby instruments 10, one for the use of the pilot and the other for the use of the copilot.

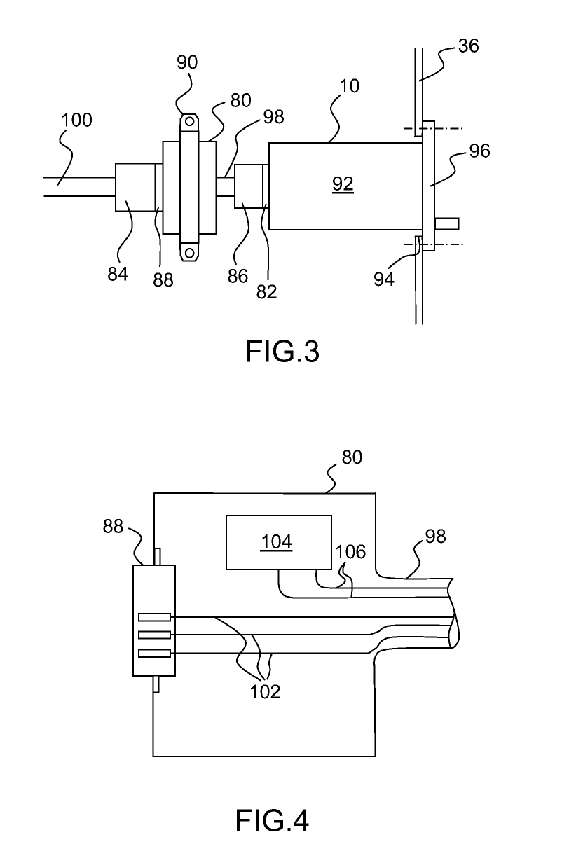

FIG. 3 represents a backup device 80 associated with the standby instrument 10. The instrument panel 35 comprises a plate 36 to which are fixed the various navigation instruments, and in particular the standby instrument 10. The standby instrument 10 comprises a first connector 82 intended to be connected, in the absence of the backup device 80, to a second connector 84 belonging to the aeroplane. The backup device 80 is connected between the connectors 82 and 84.

The backup device 80 comprises a connector 86 similar to the connector 84 and designed to be connected to the connector 82 of the standby instrument 10 and a connector 88 similar to the connector 82 and designed to be connected to the connector 84 of the aeroplane. The backup device 80 comprises fixing means intended to firmly attach it to the aircraft and in particular to the instrument panel 35. In the example represented, a flange 90 forms these fixing means.

The instrument panel 35 comprises means to enable the standby instrument 10 to be removed while keeping the backup device 80 firmly attached to the aircraft. To this end, a body 92 of the standby instrument 10 can be installed through an opening 94 in the plate 36. A front panel 96 of the standby instrument 10 then bears against the plate 36 and locking means, such as, for example, quarter-turn screws, not shown, are used to secure and position the standby instrument 10 on the plate 36. The backup device 80 may include a flexible cable 98 terminating in the connector 86. Thus, to remove the standby instrument 10, the locking means are undone in order to extract the body 92 from the instrument panel 35 through the opening 94. The flexible cable 98 is long enough to allow the body 92 of the standby instrument 10 to completely leave the opening 94 while retaining the connection of the standby instrument 10 and of the backup device 80. Disconnection can then be done easily outside the instrument panel 35. The standby instrument 10 is reinstalled by reversing the removal operations. First of all, the standby instrument 10 is connected to the backup device, then the standby instrument 10 is positioned in the opening 94 and it is fixed to the instrument panel 35.

As a variant, it is possible to fix the backup device to the standby instrument 10. The connector 84 may form one end of a flexible cable 100, often called aeroplane cable. In this variant, when removing the standby instrument 10, the flexibility aeroplane cable 100 makes it possible to extract the connector 84 through the opening 94. Outside the instrument panel, the backup device 80 and the standby instrument 10 can be electrically and mechanically uncoupled. During this operation, the backup device 80 remains firmly attached to the aeroplane cable 100.

FIG. 4 represents the interior of the backup device 80. The backup device 80 appears to be in series in the link between the standby instrument 10 and the aeroplane cable 100. This is true mechanically, but not electrically. The backup device is said to be electrically transparent between the standby instrument 10 and the aeroplane cable 100. In other words, all the links 102 of the aeroplane cable 100 ending at the connector 84 pass through the backup device 80 to the connector 86 with no electrical interaction with the backup device 80. Among these so-called transparent links, there are, for example, power supply links for the standby instrument 10 and links for information interchanges between the aeroplane and the standby instrument 10. These links are, for example, defined by an aeronautical communication standard such as, for example, one of the ARINC (Aeronautical Radio Incorporated) standards implemented by many manufacturers and airlines.

The backup device 80 comprises backup means 104 connected only to the standby instrument 10 by means of the connectors 82 and 86 through the cable 98. Links 106 provide the feed for the backup means 104 from the standby instrument 10 and handle the transfer of information between the backup means 104 and the standby instrument 10. No link passes directly from the aeroplane cable 100 to the backup means 104. The connector 84 forming the end of the aeroplane cable 100 generally comprises unused pins. The corresponding pins of the connector 82 of the standby instrument 10 are used for the links 106.

The backup device can be used to store calibration information for the standby instrument 10. Thus, a calibration performed on a standby instrument 10 can be reused if the latter is replaced following, for example, a failure.

The standby instrument 10 advantageously comprises a magnetometer used to determine the heading of the aeroplane and display it in the area 22 of the screen 12. The magnetometer may also be situated outside the standby instrument 10. The information that it delivers is then conveyed by the aeroplane cable 100 to the standby instrument 10. As seen previously, the calibration of the magnetometer is a lengthy operation and is used to determine the corrections to be made to the values measured by the magnetometer according to the environment to which the standby instrument 10 is subject. All of these corrections form the calibration information regarding the magnetometer. Such information is stored by the backup means 104.

Advantageously, the standby instrument 10 comprises means for storing the calibration information each time the power supply to the standby instrument 10 is interrupted. When the standby instrument 10 is no longer powered, the backup device 80 also loses its feed. To retain the calibration information, provision can be made for the backup means 104 to include a non-volatile memory, such as, for example, an electrically-erasable read-only memory, well known in the literature by the name “EEPROM”, or even a fast programmable read-only memory, well known in the literature by the name “FlashPROM”. Each time the power supply for the standby instrument 10 is restored, said instrument recovers the calibration information from the backup device 80.

Thus, to replace the standby instrument 10, it will not be necessary to provide any particular procedure for backing up the calibration information. Before its removal, the standby instrument 10 stores its calibration information in the backup device 80 as soon as the power supply is cut. The new standby instrument 10 recovers the same information as soon as it is powered up.

It will be readily seen by one of ordinary skill in the art that embodiments according to the present invention fulfil many of the advantages set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

1. A device for backing up calibration information for an air navigation instrument intended to be installed in an aircraft, the air navigation instrument comprising a first connector intended to be connected to a second connector belonging to the aircraft,
wherein the device is designed to be connected between the first and the second connectors, and
wherein the device comprises a third connector similar to the first connector and designed to be connected to the second connector and a fourth connector similar to the second connector and designed to be connected to the first connector, and
wherein all the links from the second connector pass through the device to the fourth connector with no electrical interaction with the device, and
wherein the device further comprises backup means connected only to the air navigation instrument by means of the first and fourth connectors.

2. The device according to claim 1, wherein the backup means are supplied by the air navigation instrument.

3. The device according to claim 1, wherein the backup means comprise a non-volatile memory.

4. The device according to claim 1, further comprising fixing means intended to attach it firmly to the aircraft.

5. An aircraft instrument panel including a backup device according to claim 1 and an air navigation instrument.

6. An aircraft instrument panel according to claim 5, further comprising means for enabling the air navigation instrument to be removed while keeping the backup device firmly attached to the aircraft.

7. The aircraft instrument panel according to claim 5, wherein the air navigation instrument comprises a magnetometer and wherein the calibration information relates to the magnetometer.

8. The aircraft instrument panel according to claim 5, wherein the air navigation instrument comprises means for storing the calibration information each time the power supply to the air navigation instrument is interrupted.

9. The aircraft instrument panel according to claim 5, wherein the air navigation instrument is a standby instrument and further comprising means for determining and displaying the altitude, attitude and heading of the aircraft.
